(19) United States
(12) Patent Application Publication
(10) Pub. No.: US 2009/0128573 A1
(43) Pub. Date: May 21, 2009

(54) Memory Based Content Display Interception

(76) Inventors: Canice Lambe, Dublin (IE); Garrett Hussey, Wexfort (IE)

Correspondence Address: K&L Gates LLP, STATE STREET FINANCIAL CENTER, One Lincoln Street, BOSTON, MA, 02111-2950, US

(21) Appl. No.: 11/884,101

(22) PCT Filed: Feb. 9, 2006
(86) PCT No.: PCT/IB06/01796

§ 371 Date: Mar. 20, 2008

Related U.S. Application Data
(60) Provisional application No. 60/651,327, filed on Feb. 9, 2005.

(51) Int. Cl. G06T 1/60

(52) U.S. Cl. 345/530

(57) ABSTRACT

In one aspect, the invention relates to a method for blocking or otherwise regulating content. The method includes the steps of intercepting a call to a graphics API; determining if the image meets the requirements for further analysis; and if the image meets the requirements for further analysis, generating a structure to represent the array of pixels in the image; analyzing the image structure for determination of inappropriate content; and preventing the display of the image if the determination is that the content is inappropriate.

### RELATED APPLICATIONS

This application claims priority to U.S. Provisional Patent Application 60/651,327 filed on Feb. 9, 2005, the disclosure of which is herein incorporated by reference in its entirety.

### FIELD OF THE INVENTION

The invention relates generally to the field of content control and user access regulation. Specifically, the invention relates to devices and methods for regulating access to certain types of content.

### BACKGROUND OF THE INVENTION

Whether content displayed on a computer screen is inappropriate for viewing is a function of many factors. These factors include the disposition of the viewer, the nature of the content, the purpose for accessing the content, and the location at which the content is being viewed. For example, content that is appropriate for an adult medical professional in a work setting may not be appropriate for a minor in a library setting. Similarly the cinematic content that a parent allows a teenager to view may differ from the content that is deemed appropriate for a younger child.

The desire to block and regulate objectionable material has increased in conjunction with the use of the internet and the increased availability of objectionable or pornographic material. The proliferation of storage devices such as digital cameras and image receiving cell phones have also fueled this desire. In part, the demand for content regulation has arisen because of the potential liability that individuals and companies face when illicit content is accessed or stored using their systems. As a result, companies and individuals require means to limit access to materials they define as objectionable.

Furthermore, with increasing levels of investor scrutiny and auditor review, a need exists for tools and methods that allow companies and individuals to regulate the content that customers and employees access. In concert with this need, mechanisms that allow companies to establish levels of access control to prevent unnecessary content restriction are also desirable.

### SUMMARY OF THE INVENTION

In one aspect, the invention relates to a method of regulating content. The method includes the steps of intercepting a call to a graphics API, the call associated with an image, determining if the image meets a requirement for further analysis, if the image meets the requirement for further analysis, generating a structure to represent the image, analyzing the image structure to determine if the image contains inappropriate content, and preventing the display of the image if the content is inappropriate. In one embodiment of the method, the structure can include, but is not limited to a DIB structure, a JPEG structure, a TIF structure, a memory element, image data, and an image structure native to the graphics API. The step of intercepting the call to the graphics API can be performed using a proxy DLL, patching an address table of a binary program file, patching at least one API call, and other techniques. Additionally, the step of preventing the display can be performed in various ways such by replacing the image with another image; blending the image with a second image; distorting the image and otherwise transforming or blocking the image.

In another aspect, the invention relates to content regulation system. The system includes a graphics API call interceptor adapted to respond to content access, an image determination module in communication with the graphics API call interceptor, the image determination module adapted to determine if an image meets the requirements for further analysis, a structure generator in communication with the image determination module to represent the array of pixels in the image as a structure if the image meets the requirements for further analysis, an image analyzer in communication with the structure generator, the image analyzer determining if there is inappropriate content within the structure, and a display modifier in communication with the image analysis module to modify the image if the determination is that the content is inappropriate. The image can reside in memory. In one embodiment, the structure can include, but is not limited to a DIB structure, a JPEG structure, a TIF structure, a memory element, image data, and an image structure native to the graphics API. The system can further include a cache, wherein the cache is analyzed for image data that contains inappropriate content. The image analyzer can generate a pointer in response to inappropriate content, wherein the pointer is stored in the cache and points to image data.

In another aspect, the invention relates to a method of blocking content from being displayed. The method includes the steps of intercepting a call to a text API, the call related to a text segment, analyzing the text segment to determine if the text segment contains inappropriate content, and preventing the display of the text segment if the determination is that the content is inappropriate. In one embodiment, the method further includes the step of displaying an altered version of the text segment if the content is inappropriate.

In another aspect, the invention relates to a method of regulating access to content, the method includes the steps of intercepting an image display call associated with an image prior to the image being displayed to a user, evaluating the image using an image processing engine to generate a probability value in response to the image, the probability value indicative of a likelihood that the image contains inappropriate content, and regulating access to the image based upon an existing probability threshold. In one embodiment, the method further includes the step transforming the image to substantially obscure the image in response to the existing probability threshold. The step of transforming the image can be performed on a per pixel basis, in system memory, by using a proxy DLL, and by other techniques and devices disclosed herein.

The step of intercepting the image display call can be performed by patching address tables of a binary program file and/or by patching at least one API as well as other techniques.

The invention relates to a method and apparatus for blocking content from being viewed. The method includes the steps of intercepting a call to a graphics Application Programming Interface (API), determining if the image meets the requirements for further analysis, and if the image meets the requirements for further analysis, generating a structure to represent the array of pixels in the image, analyzing the image structure for determination of inappropriate content, and preventing the display of the image if the determination is that the content is inappropriate.

In one embodiment the interception of the call to a graphics API is performed by a proxy DLL. In another embodiment the intercepting of the call to a graphics API is performed by patching address tables of a binary program file.

In yet another aspect, the apparatus for blocking content from being viewed includes a graphics API call interceptor, an image determination module in communication with the graphics API call interceptor for determining if the image meets the requirements for further analysis, a structure generator in communication with the image determination module to represent the array of pixels in the image as a structure if the image meets the requirements for further analysis, an image analyzer in communication with the structure generator for determination of inappropriate content within the image of the structure, and a display modifier in communication with the image analysis module to modify the image in the structure if the determination is that the content is inappropriate.

It should be understood that the terms “a,” “an,” and “the” mean “one or more,” unless expressly specified otherwise.

The foregoing, and other features and advantages of the invention, as well as the invention itself, will be more fully understood from the description, drawings, and claims which follow.

### BRIEF DESCRIPTION OF THE DRAWINGS

The objects and features of the invention can be better understood with reference to the drawings described below, and the claims. The drawings are not necessarily to scale, emphasis instead generally being placed upon illustrating the principles of the invention. The drawings associated with the disclosure are addressed on an individual basis within the disclosure as they are introduced.

FIG. 1 is a flow chart depicting calls made to a graphics display interface by two applications according to an illustrative embodiment of the invention;

FIG. 2 is an example of multiple types of content as displayed on a computer screen;

FIGS. 3a-3d are flow charts depicting various ways in which an API call to a DLL may be modified according to an illustrative embodiment of the invention;

FIG. 3e is a flow chart depicting the program flow for a conventional call to a subroutine X in a target DLL.

FIG. 3f is a flow chart depicting the program flow for a subroutine X that has been patched.

FIG. 4a is a generalized flow diagram depicting API interception of text content according to an illustrative embodiment of the invention;

FIG. 4b is a generalized flowchart depicting API interception of image content according to an illustrative embodiment of the invention;

FIG. 4c is a flowchart depicting additional detail relating to the embodiment shown in FIG. 4b;

FIG. 5a is image depicting an example of unaltered content that can be analyzed and regulate using the apparatus and methods of the invention;

FIG. 5b is an image depicting the masking of the image from FIG. 5a using an alpha blend effect according illustrative embodiment of the invention;

FIG. 5c is an image depicting the masking of the image from FIG. 5a using a blurring effect according illustrative embodiment of the invention;

FIG. 5d is an image depicting the blocking of the image from FIG. 5a using a pre-generated sign according illustrative embodiment of the invention;

FIGS. 6a and 6b are schematic diagrams depicting an exemplary method by which objectionable content is excluded from a display according to an illustrative embodiment of the invention;

FIG. 7 is a schematic diagram depicting a screen permitting the override of a content blocking function according to an illustrative embodiment of the invention; and

FIG. 8 is a block diagram of a system capable of implementing an embodiment of the present invention.

The claimed invention will be more completely understood through the following detailed description, which should be read in conjunction with the attached drawings. In this description, like numbers refer to similar elements within various embodiments of the present invention.

### DESCRIPTION OF THE PREFERRED EMBODIMENT

The following description refers to the accompanying drawings that illustrate certain embodiments of the present invention. Other embodiments are possible and modifications may be made to the embodiments without departing from the spirit and scope of the invention. Therefore, the following detailed description is not meant to limit the present invention. Rather, the scope of the present invention is defined by the appended claims.

It should be understood that the order of the steps of the methods of the invention is immaterial so long as the invention remains operable. Moreover, two or more steps may be conducted simultaneously or in a different order than recited herein unless otherwise specified.

In general, the aspects and embodiments of the invention disclosed herein relate to content regulation and access management. As workers make greater use of web-based technologies, exposure to diverse types of written and visual stimulation increases. In advertent exposure to certain categories of content, such as pornography, violent images, profanity, and others, can put a business at risk. These risks can be from employee lawsuits, damaging results from a forensic review of computer files, and other events that expose a business or individual to liability. However, various business models require the handling of graphic images and/or publications for which the determination of what is objectionable content is more subjective. As a result, the content management apparatus and methods disclosed herein can be tailored for particular content levels as appropriate for a given work environment.

In general, the aspects and embodiments described herein offer methods and devices that integrate with a particular user's daily activities using a software and memory based system. The methods of the invention are integrated with a particular operating system such that a user need not affirmatively takes steps to regulate or otherwise block inappropriate content. For example, typically, the act of a user clicking on a particular webpage link or file icon may result in a browser or other image display application displaying a particular image to a user. In the absence of any intervening programming the user is exposed to the content. In contrast, the apparatus and methods disclosed herein operate to intercept the display process once a user triggers an event that could lead to the display of inappropriate content. In some embodiments, the interceptor function, i.e. the ability to prevent the display of unanalyzed content to user is resident in memory to ensure constant monitoring. In other embodiments, a predetermined threshold level is set such that once content is evaluated and assigned a particular probability rank the image initially selected by the user is either displayed; displayed in a filtered or otherwise modified form, or not displayed. In still other embodiments the user has the ability to temporarily or permanently disable the overall interception, analysis, and selective display system based on the user's access rights.

In order to understand some implementations of the invention, a review of the image processing functions in an exemplary operating system will be informative. The Windows Graphics Device Interface (WGDI) provides functions and related structures that an application can use to generate graphical output for displays, printers, and other devices. As used herein, the term Graphics Device Interface (GDI) includes, but is not limited to the Windows GDI, Windows GDI+, DirectDraw, and combinations thereof. GDI functions are used to draw lines, curves, closed figures, paths, text, and bitmap images. The color and style of the items drawn depends on the drawing objects such as the pens, brushes, and fonts as used in a given situation.

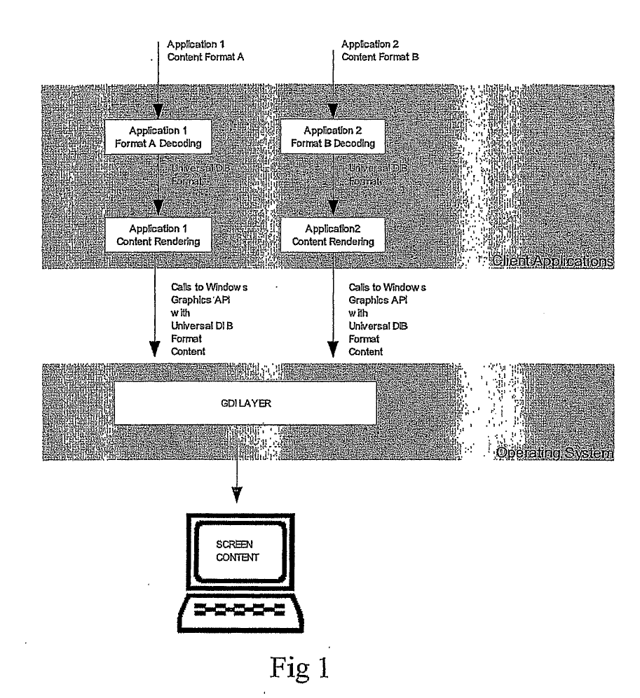

FIG. 1 illustrates two different applications (applications 1 and 2), each with different and proprietary formats (formats A and B respectively) internally converting proprietary formats to the universal DIB format. The applications then invoke the application rendering logic to render the content. The application rendering logic in turn invokes a GDI passing both the DIB data structures and other appropriate parameters to the operating system. The memory resident aspect of the invention is adapted to intercept a suitable function call and prevent a given application from displaying content as appropriate given a particular content tolerance level.

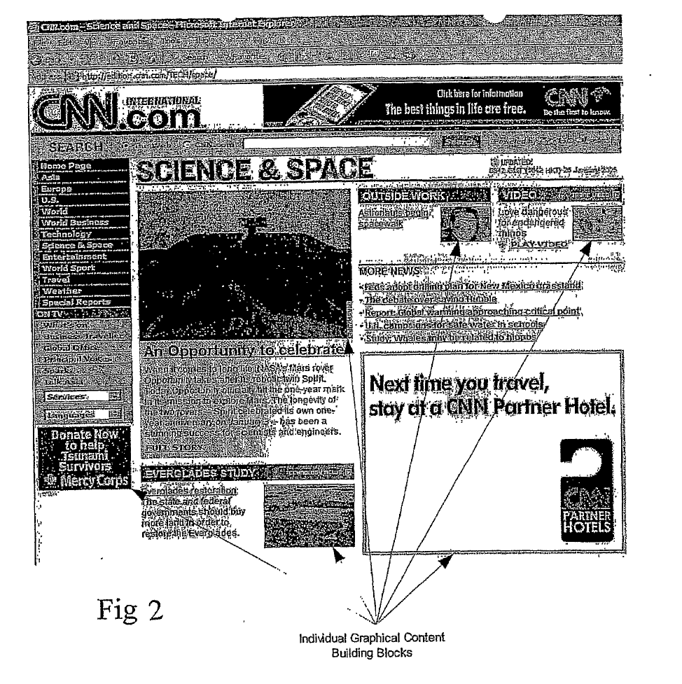

FIG. 2 illustrates a composite window display that includes multiple images and text content. In some operating systems, each image is rendered via separate calls to the GDI. The aspects of the invention is adapted to intercept those calls. Thus, the aspects and methods of the invention can regulate the content as shown in FIG. 2 from being displayed in the event that any of its is inappropriate. Alternatively, the content regulation methods disclosed herein can transform the content into an altered from the renders the offensive material substantial non-viewable.

Applications, such as shown in FIG. 1, direct output to a specified device by creating a device context (DC) for the device. The device context is a GDI-managed structure containing information about the device, such as its operating modes and current selections. An application creates a DC by using device context functions. GDI returns a device context handle, which is used in subsequent calls to identify the device. For example, using the handle, an application can retrieve information about the capabilities of the device, such as its technology type (display, printer, or other device) and the dimensions and resolution of the display surface.

Applications can direct output to a physical device, such as a display or printer, or to a logical device, such as a memory device or metafile. Logical devices give applications the means to store output in a form that is easy to send subsequently to a physical device. In contrast to systems that continually make individual calls to write to a physical device in response to the need to redraw part of the window content, the use of memory and a logical device as described herein offer performance advantages.

Applications use attribute functions to set the operating modes and current selections for the specified device. The operating modes include the text and background colors, the mixing mode (also called the binary raster operation) that specifies how colors in a pen or brush combine with colors already on the display surface, and the mapping mode that specifies how GDI maps the coordinates used by the application to the coordinate system of the device. The current selections identify which drawing objects are used when drawing output.

Most applications involve the rendering of text content. The application stores the text content and the appropriate formatting information in its proprietary format. When displaying the text, the application uses the GDI to set the various font attributes and then make a call to a function, such as TextOut. The TextOut function writes a character string at the specified location, using the currently selected font, background color, and text color. The character string that TextOut receives is format free and represents what the user will see. It therefore can be analyzed for profanities and other inappropriate content. This analysis can be performed without concern that the text content will have application specific constructs embedded that will make analysis application specific.

When capturing an image from real-life sources, image data needs to be converted to a digitized format for storage in memory, secondary storage, or the transmission to a remote device. Different operating systems, hardware vendors and software applications store images in different formats. Common image formats include: JPEG (developed by Joint Photographic Experts Group); TIFF (developed by Aldus); GIF (developed by CompuServe) and PNG (Portable Network Graphics).

The image format native to the Windows OS is the BMP (bitmap) or DIB (device independent bitmap) image format. Compared to other image formats the DIB is a very simple image format designed for easy graphics programming within an application. However, images in DIB format can require significantly more storage than the formats mentioned above. For example, a 1024×768 24 bit true color DIB image is 2.25 MB. The same image in JPEG format may be only 200K.

When rendering content to a graphical device, a given application typically converts the image into the DIB format. An example of the process is discussed below with respect to FIG. 1. Once in DIB format the application advantageously uses a plurality of (API) calls to render the image to the screen. For example, the API call, StretchDIBits, can be used. This API call includes various parameters such as the device context (DC) discussed above. The co-ordinates for the top right corner of the bitmap that are part of the DC are another API call parameter. In addition, other API call parameters include the width and height in pixels within the device context for the image, which may result in the image being stretched or shrunk to fit this width and height; the co-ordinates of the top left region within the DIB to be drawn (typically (0,0) if drawing the full image); and the width and height in pixels of the region within the DIB to be drawn corresponding to the image width and height in pixels if the whole image is to be drawn. The API call parameters can also include a pointer to the array of pixels contained in the image; a pointer to a bitmap info structure relating to the internal structure of the DIB; and additional parameters governing exact display behaviour. In various embodiments, the API calls interact with suitable computer display hardware.

Hardware acceleration using AGP or PCI-E based cards provides various advantages to a computer user. This form of hardware acceleration is used in many computer systems. Support for hardware-accelerated 2-D graphics is provided in various operating systems. The Microsoft DirectDraw API provides this functionality in the Windows environment. The aspects and embodiments of the invention can use any of the three graphics subsystems, GDI, GDI+ or DirectDraw.

The DirectDraw API is compatible with the Windows graphics device interface (GDI). The API also offers fast access to display hardware. Specialized memory management is one feature of the API. This memory management is available for both system and display device memory. DirectDraw provides applications, such as games, and other OS subsystems use the capabilities of specific display devices. The device-independent operation of the API is another advantage of the API.

Two-dimensional vector graphics, imaging, and typography are handled by Microsoft Windows GDI+ in some versions of the Windows operating system. GDI+ is an enhancement of the Windows Graphics Device Interface. The GDI+ API adds new features and optimizes existing features. In addition, GDI+ allows native handling of JPEG image and various other formats.

The methods, apparatus and modules disclosed herein that are intended to interfere with the display of content intercept the GDI calls in order to modify their behaviour. The interception of Windows API calls can be done in the following ways:
“Proxy DLL”—In this interception implementation, the original dynamically loadable library (DLL) is replaced by a new DLL that adds extra functionality and makes appropriate calls to the underlying original DLL.
“Address Table Patching”—In this interception implementation, the import and export tables of the binary program files and DLLs are modified to point to the intercepting code instead of the original DLL code.
“API Patching”—In this interception implementation, the first few bytes of the “in memory” copy of the function call to be intercepted are modified to contain an unconditional jump instruction to a new location representing the intercepting function. Appropriate binary code handling ensures that the new location is valid, the arguments are preserved and that the original function can be invoked from the intercepting function if appropriate.

The Proxy DLL technique involves writing a “proxy” DLL to be exchanged with the original DLL. A stub function or program that simply passes parameters is generated for each member of the target DLL using the same parameter list. In general, this requires access to an API declaration for the underlying DLL library such as wingdi.h.

Typically, only a small number of API calls need be intercepted to regulate the content, with the remainder being simply passed through to the underlying API function. A linker directive used by the programmer can directly specify a “pass through” to the underlying function. However, for the methods of interest; the programmer can also cause code to be executed before and after the underlying function call to achieve the desired effect.

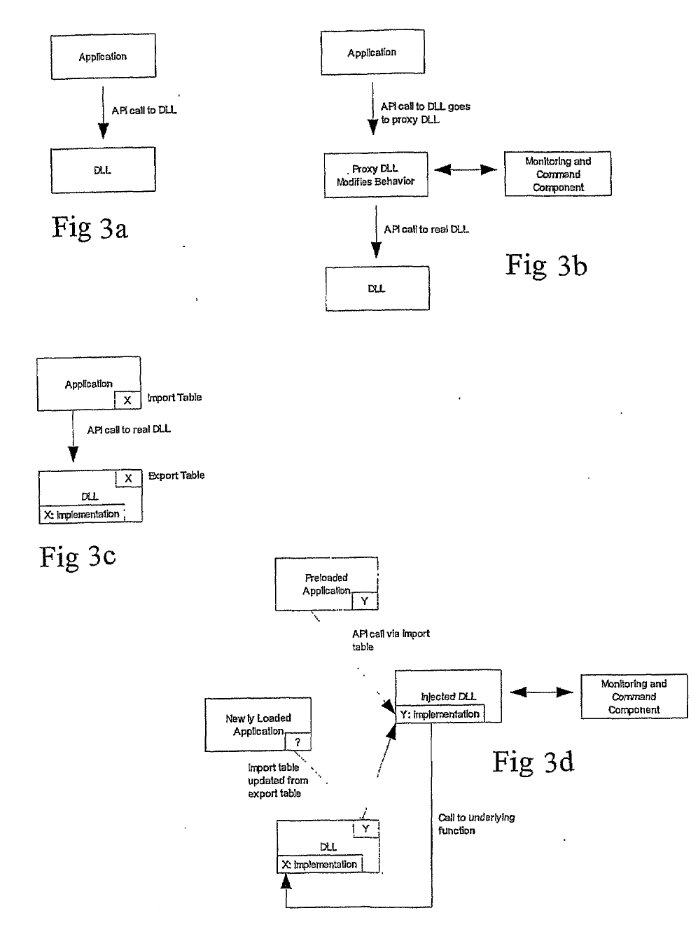

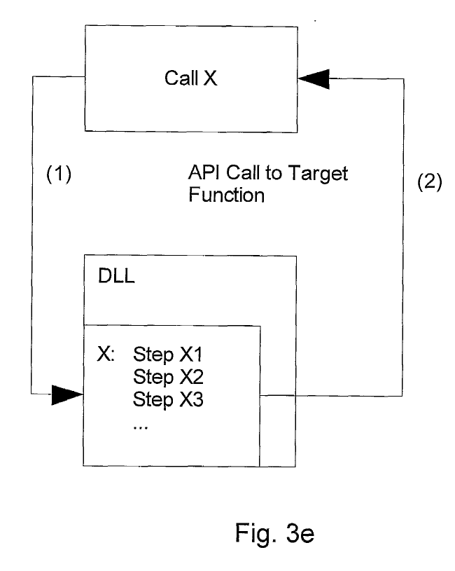

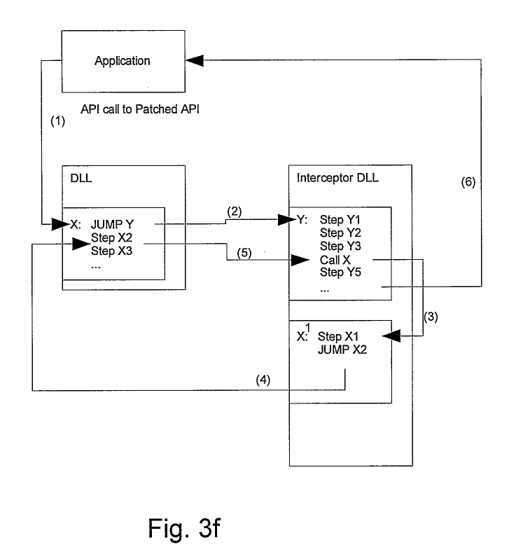

FIG. 3a illustrates the normal of an application making API calls to an underlying Windows GDI DLL. FIG. 3b illustrates an embodiment where the original GDI DLL has been replaced by a proxy DLL. The proxy DLL can modify the behaviour of the original API call in addition to simply invoking the original call. Furthermore, the proxy DLL can communicate by shared memory, files or some other means of inter process communication to a separate monitoring and command component in order to report on interceptions and take configuration input.

Standard 32-bit Windows executable files and DLLs are built upon the Portable Executable (PE) file format. Files based on this specification are composed of several logical portions known as sections. Each section contains a specific type of content. For example, the “.text” section holds the compiled code of the application while the “.rsrc” section serves as a repository for resources such as dialog boxes, bitmaps and toolbars.

Among all of the sections present in a Windows executable file, the “.idata” section is particularly useful for implementing an API interceptor. A special table located in this section known as the Import Address Table (IAT) holds file-relative offsets to the names of imported functions referenced by the executable's code. Whenever Windows loads an executable into memory, it patches these offsets with the correct addresses of the imported functions.

FIG. 3c illustrates how, in the normal situation, the import table of a calling application stores a value taken from the export table of the underlying DLL which points to the implementation of the underlying API call. In this case, the API interception solution includes the use of a driver DLL and controller application, which injects the driver DLL into the target process. The driver DLL communicates with its controller application by shared memory, files or some other means of inter-process communication.

Once the driver DLL has been injected into the target process, it overwrites IAT entries of the target module with the addresses of user-defined proxy functions, implemented by the driver DLL. Each IAT entry replacement normally requires a separate proxy function. The proxy function knows which particular API function it replaces so that it can invoke the original calling routine.

As part of the interception process, in addition to overwriting of IAT entries in all currently loaded modules, the Image Export Directory (IED) of the target DLL is also overwritten. When this is done, all future loading of DLLs into the target process will link with the proxy functions, although all currently loaded modules are not going to be affected. By combining the modification of IATs of all currently loaded modules with overwriting the IED of the target DLL itself, all calls that are made to the target DLL by absolutely all (including yet-to-be-loaded) modules in the address space of the target process will be intercepted. Apart from the target process, all other processes in the system will stay intact. Therefore this is done for each process for which the interception is to occur. FIG. 3d illustrates how both existing executables have their import tables updated and how new executables will retrieve the import table value from the modified export table. In either case, the executable will point to the injected DLL rather than the original. The figure also indicates how the injected DLL can invoke the functionality in the underlying DLL.

The Detours library is provided by Microsoft. This library enables the interception of functions using the “API Patching” technique discussed above. Typically, interception code is applied dynamically at runtime. This application of the code ensures continuous operation. Once running, the Detours library facilitates the replacement of the first few instructions of the target function with an unconditional jump to the user-provided detour function. In a preferred embodiment, the MS Detours library is used to intercept API calls from the GDI, DirectDraw and GDI+ graphics subsystems for purposes of protecting the user from illicit content.

In turn, instructions from the target function are stored in a director function. Instructions removed from the target function are incorporated in the director function. The director function can also include an unconditional branch to the remainder of the target function. Replacing the target function or extending its semantics by invoking the target function as a subroutine through the director is typically handled by the detour function.

During execution time, the detour functions are invoked. Modification of the target function is performed in memory, thereby facilitating interception of binary functions in real time with reduced error. This provides many advantages over performing this modification step via Proxy DLL. These advantages include, the ability to selectively patch certain applications and not interfere with other applications; the ability to patch and unpatch within the same user session (proxy dll would require a rename and reboot); and the fact that the Microsoft OS binaries remain intact and therefore warranties relating to PC operations are not compromised. As an example, the procedures in a DLL can be detoured in one execution of a first application such as shown in FIG. 1, while the original procedures are not detoured in a second application running at the same time.

As time passes, eventually the program execution calls the target function, at this point in time the process control of the program switches. Specifically, the user-supplied detour function takes over and re-directs the process flow. Any necessary interception preprocessing is handled by the detour function. Additionally, the detour function may later relinquish control to the source function. Alternatively, the detour function is capable of initiating a call to the director function. As a result of this call, the target function is invoked without interception. Following completion of the target function's tasks, control returns to the detour function. Any appropriate post-processing is performed by the detour function. After any post-processing, control is returned to the source function.

FIG. 3e shows the program flow for a conventional call to a subroutine X in a target DLL. The execution proceeds to the first instruction, Step X1, in subroutine X and then to Step X2, . . . etc. On completion, the execution returns to the calling routine. FIG. 3f shows the program flow for a subroutine X that has been patched. The execution moves to the first instruction in the patched routine which is an unconditional jump to the interceptor routine Y. The execution then commences with the instructions of subroutine proceeding from Step Y1 to Step Y3. At this point in the exemplary embodiment, the program calls the underlying logic of subroutine X. A call is made to the director function X1 in the interceptor DLL which executes the first instructions of the original routine (overwritten in the original DLL by the unconditional jump) and then makes an unconditional jump to the subsequent instructions of the original routine X so the net effect is that the original instructions of X in their entirety have been called. On completion of subroutine X, the code resumes with further instructions in the interceptor function Y and finally on completion of Y, the code returns to the calling routine.

Within the GDI there is a subset of calls for the rendering of text content to screen once the appropriate presentation attributes (font, color, etc.) have been specified. One of the parameters of these calls is the text buffer to be displayed. The intercepted calls are analyzed to determine if the text content includes profanities or other restricted content based on an updateable list. This list is typically distributed with a software implementation of the methods described herein. For each profanity described, there is an equivalent “modified string” for that profanity. For example, where “fish” is a profanity, then the modified string might be “f**h”.

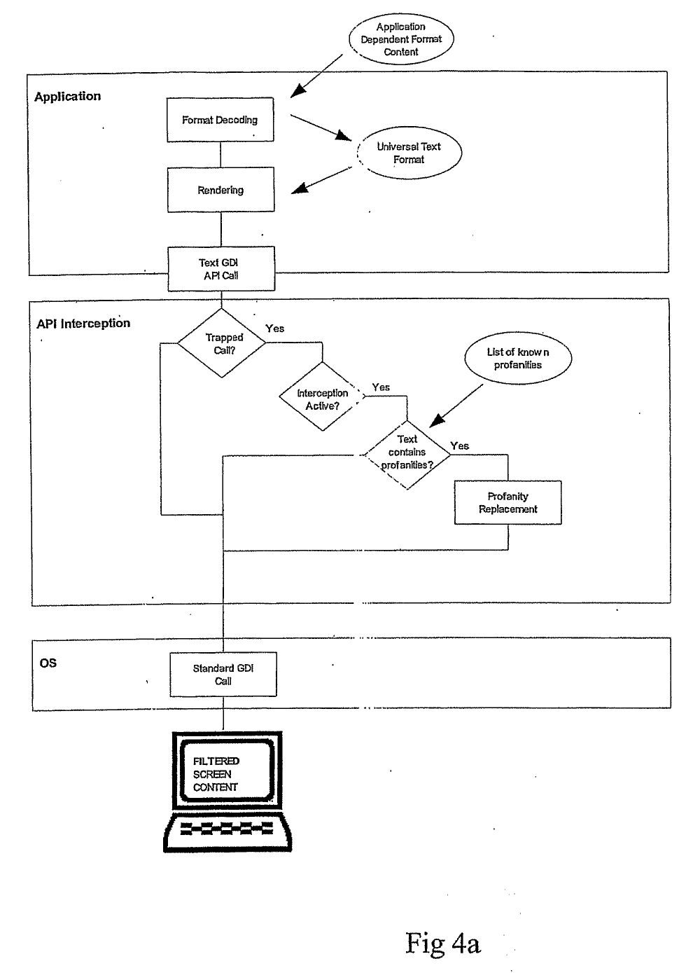

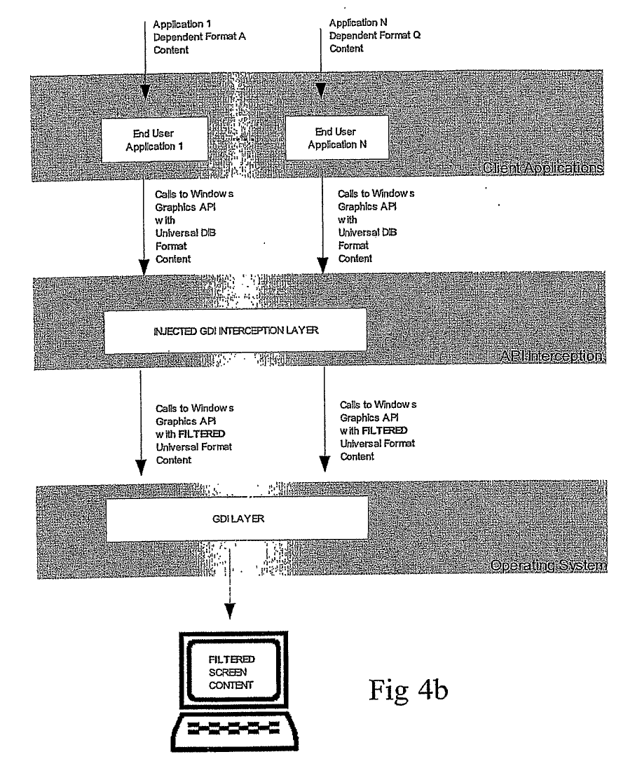

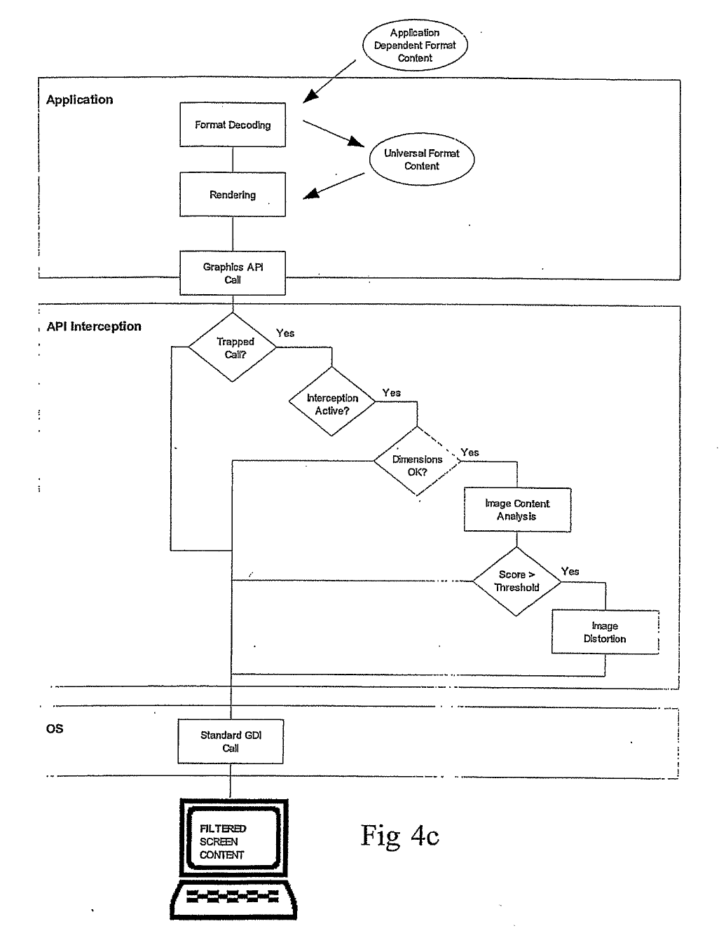

If a profanity is present, the system creates a new text buffer with the original content and a new text buffer containing a substitution of any detected profanities within the modified strings. The system then passes the new text buffer to the underlying call instead of the original text buffer. The original text buffer is not modified as it may point to live data within the application. A flow diagram for an embodiment of a process for the interception of in appropriate text-based content t is shown in FIG. 4a.

Within the GDI there is a subset of calls for the rendering of bitmap content in DIB format and DDB format to graphic devices. These function calls include:
StretchDIBits
SetDIBitsToDevice
BitBIt
StretchBlt

The StretchBlt function takes as parameters a source device context with rectangular co-ordinates and a destination device context with rectangular co-ordinates. This function is used as follows to mask inappropriate content:
Check the dimensions of the bitmap if not of interest (e.g. too small an area as described below) then simply pass the call through to underlying GDI call and then return.
Else generate a DIB structure to represent the array of pixels to be copied from the source device context.
Pass the DIB structure to the image analysis algorithm and determine, if it passes the threshold for inappropriate content.
If the image is rated as inappropriate then distort the pixels in the source device context designated by the source parameters of the API call.

This approach has certain efficiency advantages, specifically, since the source device context has been altered, any windows refresh events may directly recopy the distorted image, no further image analysis work will be required. FIGS. 4b and 4c illustrate the flow control within the interceptor code that achieves this objective.

The SetDIBitsToDevice function uses a destination device context with rectangular co-ordinates and pointers to a DIB bitmap information structure and array of pixels and rectangular co-ordinates. This function operates to mask or otherwise regulate the ability to view inappropriate content as follows:
Perform the underlying call to SetDIBitsToDevice
Check the dimensions of the bitmap—if not of interest (e.g. too small an area as described below) then simply pass call through to underlying GDI call and then return.
Check the cache of “remembered” pointers to arrays of bitmaps previously classified as inappropriate. If present, then note the existence of the pointers.
If the pointer is not in the cache, then generate a DIB structure to represent the array of pixels to be copied from the source device context.
Pass the DIB structure to the image analysis algorithm and determine if it passes the threshold for inappropriate content.
If the image is classified as inappropriate, then add to the list of remembered images. Use a “first in—first out” cache of remembered images to prevent the list from growing too large.
If the bitmap was in the list of remembered images or newly added to the list of remembered images, then distort the pixels in the destination device context.

The cache of remembered pointers will save unnecessary re-analysis of the image due to simple windows redraw events. The “remembered” list of images already classified as inappropriate is implemented as a list of pointers to previously supplied DIBs on previous API calls. However, a resizing of the window resulting in a resizing of the underlying content will result in new calls. If the location of the DIB changes in response to a screen resize or other event then the value of the pointer will be new and unknown to the list. One way to avoid this is by using an MD5 hash or other more robust approach which will recognize the image as being the same as a previous image as long as the MD5 hash of the pixel array is the same.

Another way to reduce the amount of analysis that is required to intercept inappropriate content is to consider window size. Typically, windows containing inappropriate image content are of a certain size and aspect ratio. If the window is too small or too thin or too narrow, then the window is unlikely to contain any content of interest. The system can be configured to only consider images within a certain width and height range. For example images with width or height less than 50 pixels are unlikely to contain inappropriate material.

Once the image has been processed, the image is passed to the underlying image analysis engine as a DIB. Any image analysis algorithm taking a DIB as input can be used. However, in other embodiments different image formats known in the art may also be used. If the algorithm takes a proprietary format, then a further operation to generate the proprietary format from the DIB is required. The algorithm takes as an input a DIB or similar file format and provides a numeric score (such as a probability or other threshold level) representing a degree of confidence that the image contains inappropriate material. In various embodiments, different image processing and content ranking engines/algorithms can be used. For example, the algorithms described in co-pending U.S. patent application Ser. No. 11/008,867, the disclosure of which is herein incorporated by reference in its entirety, can be used.

In another embodiment an “Image Composition Analysis” engine created by First 4 Internet (Banbury, Oxfordshire, United Kingdom) is used for analysis. This implementation comprises seven engines which combine their analysis of body, face, foreground, background, luminosity, edge, and texture to return a value, indicating the potential offensive nature, which can then be interpreted by a customer's own architecture. The engine is quick, processing data at speeds of 4-5 Mb per second (Approx 1 Image every 0.2 of a second), accurate, proven to be 90-95% accurate in terms of false positives and negatives in independent testing, and the software footprint is small less than 500 k.

The engine returns a number between 0 and 3. However, other ranking systems are possible. A return of 0 implies the engine believes the image to be free of inappropriate content. The levels 1-3 constitute degrees of certainty pertaining to the image containing inappropriate content. The system allows the system administrator to configure on a machine by machine basis the threshold for generating an incident or taking action. For example, a parent may wish to have a setting of 1 which will block images rated 1, 2 or 3. This setting is most likely to detect inappropriate content but will also have the highest false positive rate. By contrast, an organization with personnel working directly with images, such as a graphic design company may choose setting 3 as most pragmatic. The false positive rate will be lower but the system may be more susceptible to ignoring inappropriate content.

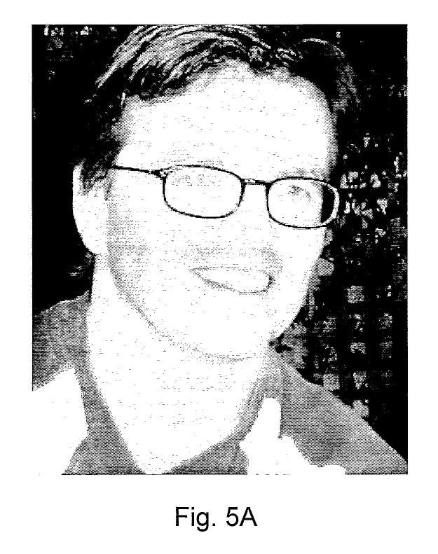

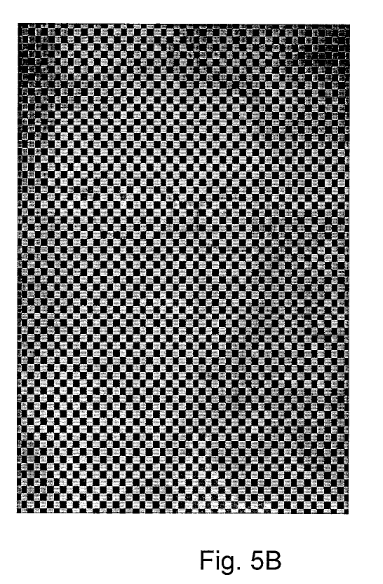

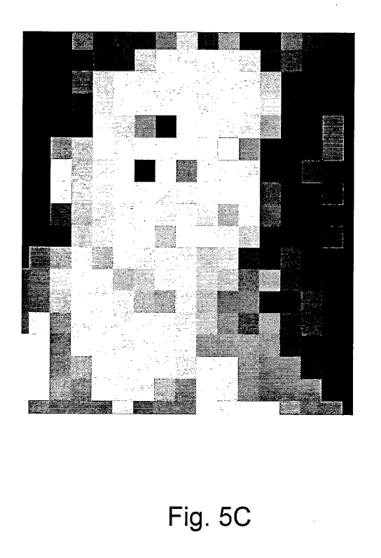

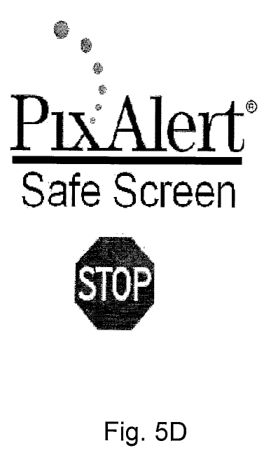

If the image contains inappropriate content, the system will distort the image so that it cannot be viewed by the user. There are a number of options as to how to achieve this distortion including for the potentially inappropriate image FIG. 5a:
Alpha blending of the image with a second image so as to provide a significantly darkened and partially opaque image as shown in FIG. 5b.
Performing some image processing algorithm so as to introduce a smoothing effect or other blurring effect as shown in FIG. 5c.
Replacement of image with other image—for example a stop sign as shown in FIG. 5d.
   On a modern PC the overhead of performing a blurring effect on the target image does not cause a noticeable performance penalty and therefore this approach (5b) is used in one embodiment of the application.

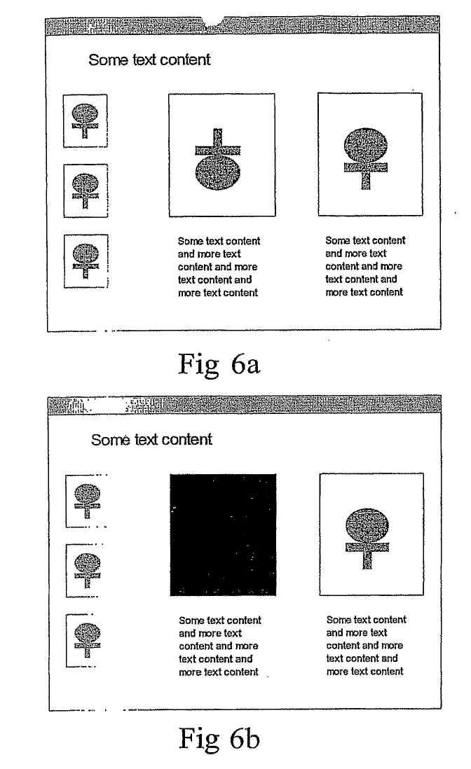

FIG. 6a illustrates a window with a mixture of graphic and text content. One of the images on the window (with the inverted symbol) is inappropriate.

FIG. 6b illustrates the display of the window if the interception solution is active, namely the content for the particular image will be distorted so as not to be clearly recognizable as inappropriate to the user.

Any image processing algorithm may misclassify certain images. These misclassifications can be either “false negatives” whereby an inappropriate image is misclassified to be okay or “false positives” whereby a neutral image is misclassified as inappropriate. In the case where the software distorts an image that the user believes to be inoffensive, the software will detect that there has been screen distortion and present the user with visual feedback via a systray icon that an image on screen has been intercepted and blurred. The user can right click on that icon and request that filtering be temporarily suspended. A dialog box will prompt the user to confirm the option to override the distorting effect of the image. If the user makes such a request, the software will temporarily suspend blocking on either a single application or alternatively all applications. The user's request to suspend blocking will be recorded by the system.

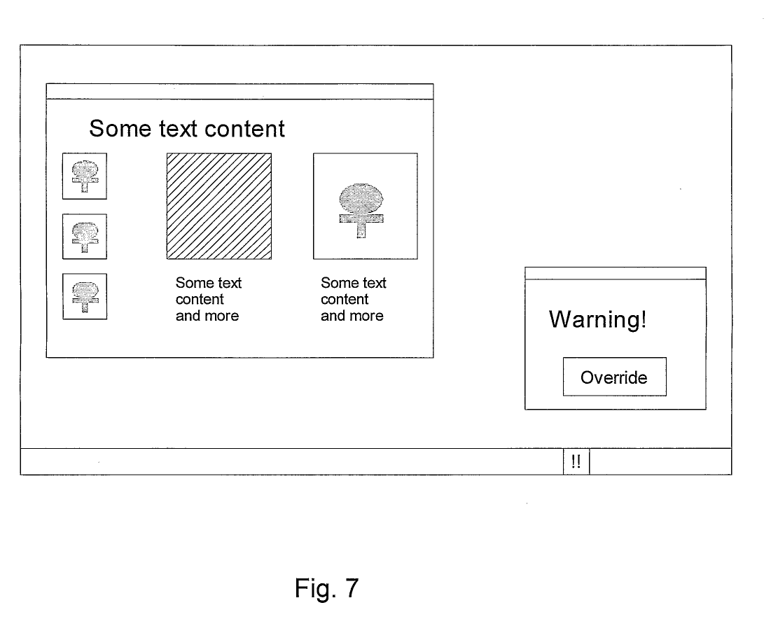

FIG. 7 illustrates a schematic representation of a user's overall screen view if the content in FIG. 6b is displayed. In addition, a window will display in the bottom right corner of the screen for a time bounded period offering the user the choice of overriding the content. This option can be disabled by the system administrator. For example, in a parental control situation, the parent may not wish to give the user the option of overriding the content.

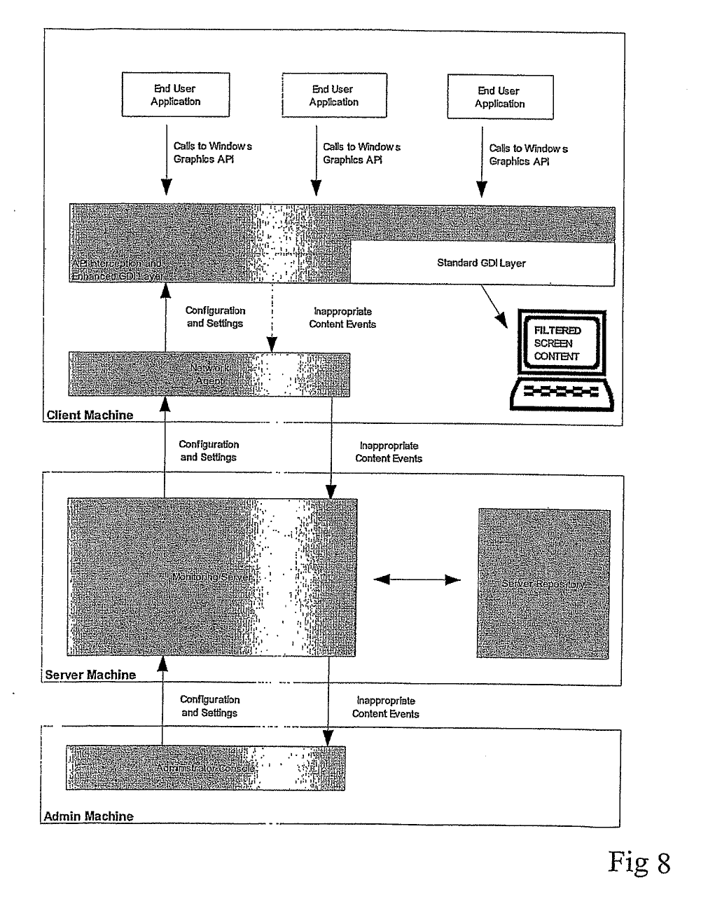

The undistorted copy of any image blocked by the system will be recorded in a secure manner along with key facts such as the application being run, the date and time and the username of the current user. In a client server configuration, this information will be periodically uploaded to the Server for purposes of alerting and reporting. In a stand alone environment (for example a home system), a separate management application can retrieve the secured information for review. FIG. 8 illustrates a client server configuration whereby in addition to screen distortion, the software will communicate the event to a remote server where it will be available for review by the Administrator.

The methods and systems described herein can be performed in software on general purpose computers, servers, or other processors, with appropriate magnetic, optical or other storage that is part of the computer or server or connected thereto, such as with a bus. The processes can also be carried out in whole or in part in a combination of hardware and software, such as with application specific integrated circuits. The software can be stored in one or more computers, servers, or other appropriate devices, and can also be kept on a removable storage media, such as a magnetic or optical disks. The embodiments described herein can also be extended for use on mobile devices such as cell phones, laptops, and PDAs.

Although some of the embodiments disclosed herein relate to the use of the Windows family of operating systems, the techniques, apparatus, systems and methods disclosed herein can also be extended to the Apple, Linux, Unix, Solaris, Palm, and other operating systems as known in the art.

It should be appreciated that various aspects of the claimed invention are directed to subsets and substeps of the techniques disclosed herein. Further, the terms and expressions employed herein are used as terms of description and not of limitation, and there is no intention, in the use of such terms and expressions, of excluding any equivalents of the features shown and described or portions thereof, but it is recognized that various modifications are possible within the scope of the invention claimed. Accordingly, what is desired to be secured by Letters Patent is the invention as defined and differentiated in the following claims, including all equivalents.

What is claimed is:

1. A method of regulating content, the method comprising the steps of:
intercepting a call to a graphics API, the call associated with an image;
determining if the image meets a requirement for further analysis;
if the image meets the requirement for further analysis, generating a structure to represent the image;
analyzing the image structure to determine if the image contains inappropriate content; and
preventing the display of the image if the content is inappropriate.

2. The method of claim 1 wherein the structure is selected from the group consisting of a DIB structure, a JPEG structure, a TIF structure, a memory element, image data, and an image structure native to the graphics API.

3. The method of claim 1 wherein the step of intercepting the call to the graphics API is performed by a proxy DLL.

4. The method of claim 1 wherein the step of intercepting the call to the graphics API is performed by patching an address table of a binary program file.

5. The method of claim 1 wherein the step of intercepting the call to the graphics API is performed by patching at least one API call.

6. The method of claim 1 wherein the step of preventing the display is performed by replacing the image with another image.

7. The method of claim 1 wherein the step of preventing the display is performed by blending the image with a second image.

8. The method of claim 1 wherein the step of preventing the display is performed by distorting the image.

9. A content regulation system comprising:
a graphics API call interceptor adapted to respond to content access;
an image determination module in communication with the graphics API call interceptor, the image determination module adapted to determine if an image meets the requirements for further analysis;
a structure generator in communication with the image determination module to represent the array of pixels in the image as a structure if the image meets the requirements for further analysis;
an image analyzer in communication with the structure generator, the image analyzer determining if there is inappropriate content within the structure; and
a display modifier in communication with the image analysis module to modify the image if the determination is that the content is inappropriate.

10. The system of claim 1 wherein the image resides in memory.

11. The system of claim 1 wherein the structure is selected from the group consisting of a DIB structure, a JPEG structure, a TIF structure, a memory element, image data, and an image structure native to a graphics API.

12. The system of claim 10 further comprising a cache, wherein the cache is analyzed for image data that contains inappropriate content.

13. The system of claim 12 wherein the image analyzer generates a pointer in response to inappropriate content, wherein the pointer is stored in the cache and points to image data.

14. A method of blocking content from being displayed comprising:
intercepting a call to a text API, the call related to a text segment;
analyzing the text segment to determine if the text segment contains inappropriate content; and
preventing the display of the text segment if the determination is that the content is inappropriate.

15. The method of claim 14 further comprising the step of displaying an altered version of the text segment if the content is inappropriate.

16. A method of regulating access to content, the method comprising the steps of:
intercepting an image display call associated with an image prior to the image being displayed to a user;
evaluating the image using an image processing engine to generate a probability value in response to the image, the probability value indicative of a likelihood that the image contains inappropriate content; and regulating access to the image based upon an existing probability threshold.

17. The method of claim 16 further comprising the step of transforming the image to substantially obscure the image in response to the existing probability threshold.

18. The method of claim 17 wherein the step of transforming the image is performed on a per pixel basis.

19. The method of claim 16 wherein the step of intercepting an image display call is performed in system memory.

20. The method of claim 16 wherein the step of intercepting the image display call is performed by a proxy DLL.

21. The method of claim 16 wherein the step of intercepting the image display call is performed by patching address tables of a binary program file.

22. The method of claim 16 wherein the step of intercepting the image display call is performed by patching at least one API.
